(19) United States
(12) Patent Application Publication
(10) Pub. No.: US 2009/0153591 A1
(43) Pub. Date: Jun. 18, 2009

(54) DISPLAY APPARATUS AND CONTROL METHOD OF THE SAME

(75) Inventors: Ho-chul SHIN, Incheon (KR); Sang-su LEE, Suwon-si (KR); Ho-nam Lee, Seoul (KR); Dale YIM, Cheonan-si (KR); Shin-haeng KIM, Yongin-si (KR); Hak-hun CHOI, Gumi-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si, (KR)

(21) Appl. No.: 12/181,606

(22) Filed: Jul. 29, 2008

(30) Foreign Application Priority Data
Dec. 12, 2007 (KR) 10-2007-0128938

(51) Int. Cl. G09G 5/10

(52) U.S. Cl. 345/690

(57) ABSTRACT

A control method of a display apparatus having a display panel formed with a plurality of pixels is provided. The method includes: detecting high gray level pixels having gray scale values greater than a predetermined high gray scale value; detecting a highlight zone including the detected high gray level pixels, wherein a gray scale value difference between boundary pixels of the highlight zone and adjacent pixels is greater than a predetermined reference difference; and applying a gray scale value greater than a gray scale value of the high gray level pixels to a surrounding zone adjacent to the highlight zone.

### CROSS-REFERENCE TO RELATED APPLICATION

This application claims priority from Korean Patent Application No. 10-2007-0128938, filed on Dec. 12, 2007, in the Korean Intellectual Property Office, the disclosure of which is incorporated herein by reference in its entirety.

### BACKGROUND OF THE INVENTION

1. Field of the Invention

The present invention relates to display apparatus and a control method of the same, and more particularly, to a display apparatus which improves the quality of an image having a local highlight zone, and a control method of the same.

2. Description of the Related Art

An image displayed on a display apparatus may have a small highlight zone. For example, stars in the sky, a spark, a ripple shining in the sun may be displayed brighter than their surroundings.

When an image taken by a camera is displayed on the display apparatus, the highlight zone may not be bright enough due to technical or mechanical limits of the camera. Furthermore, increasing the brightness of the highlight zone may be limited because of technical limits in recoding an image signal and reproducing it.

Therefore, with regard to the image having a local highlight zone, visual verisimilitude of the image may decrease and a user could not be profoundly moved.

### SUMMARY OF THE INVENTION

Accordingly, an aspect of the present invention provides a display apparatus improving the brightness of an image which has a bright zone.

Another aspect of the present invention provides a display apparatus and a control method for detecting a pixel region that is small but very bright.

According to an aspect of the present invention, there is provided a control method of a display apparatus having a display panel formed with a plurality of pixels, the method including: detecting high gray level pixels having gray scale values greater than a predetermined high gray scale value; detecting a highlight zone comprising the detected high gray level pixels, wherein a gray scale value difference between boundary pixels of the highlight zone and adjacent pixels is greater than a predetermined reference difference; and applying a gray scale value greater than a gray scale value of the high gray level pixels to a surrounding zone adjacent the highlight zone.

The method may further include determining whether the highlight zone has a predetermined critical area or less, and applying the higher gray scale value to the surrounding zone if the highlight zone has the critical area or less.

The detecting the highlight zone may include: sampling a two-dimensional pattern zone having the high gray pixel; calculating a mean gray scale value of the pattern zone; normalizing a gray scale value of the pattern zone using the mean gray scale value; converting the normalized two-dimensional gray scale value to an one-dimensional gray scale value; normalizing a El-Fallah-Ford function and converting the normalized El-Fallah-Ford function to a one-dimensional El-Fallah-Ford function; calculating an inner product with the one-dimensional El-Fallah-Ford function and the one-dimensional gray scale value; and determining whether the inner product is over a predetermined reference value.

The method may further include setting a coefficient of the El-Fallah-Ford function.

The surrounding zone may include one pixel layer surrounding the highlight zone.

The surrounding zone may occupy 5%-20% of the highlight zone.

The higher gray scale value may correspond to the sum of an original gray scale value of the surrounding zone and the gray scale value of the high gray pixels.

The method may further include applying the maximum gray scale value to the highlight zone.

According to another aspect of the present invention, there is provided a display apparatus including: a display panel which has a plurality of pixels; a panel driver which applies a gray scale value corresponding to an image signal to corresponding pixels; a highlight detector which detects high gray level pixels having gray scale values greater than a predetermined high gray scale value, and a highlight zone comprising the detected high gray level pixels, wherein a gray scale value difference between boundary pixels of the highlight zone and adjacent pixels is greater than a predetermined reference difference; and a controller which controls the panel driver to apply a gray scale value greater than a gray scale value of the high gray level pixels to a surrounding zone adjacent the highlight zone.

The controller may determine whether the highlight zone has a predetermined critical area or less and control the panel driver to apply the higher gray scale value to the surrounding zone if the highlight zone has the critical area or less.

The highlight detector may sample a two-dimensional pattern zone having the high gray pixel, normalize a gray scale value of the pattern zone, convert the normalized two-dimensional gray scale value to a one-dimensional gray scale value, and calculate an inner product with a one-dimensional El-Fallah-Ford function and the one-dimensional gray scale value.

The controller may control the panel driver to apply the maximum gray scale value to the highlight zone.

The display may further include a light unit which provides light to the display panel and locally dims, and a light unit driver which supplies driving power to the light unit so that the surrounding zone has a higher brightness than that of the highlight zone.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a control block diagram of a display apparatus according to an exemplary embodiment of the present invention;

FIG. 2 is a control flow chart describing a control method of the display apparatus according to an exemplary embodiment of the present invention;

FIG. 3 is a control flow chart describing a method for determining a highlight zone;

FIG. 4 illustrates a highlight zone according to an exemplary embodiment of the present invention;

FIG. 5A illustrates a gray scale value normalized in two dimensions;

FIG. 5B illustrates a gray scale value normalized in one-dimension;

FIG. 6 is a graph of an exemplary El-Fallah-Ford function;

FIG. 7 is a control block diagram of a display apparatus according to an exemplary embodiment of the present invention; and

FIG. 8 is a control flow chart describing a control method of the display apparatus according to an exemplary embodiment of the present invention.

### DETAILED DESCRIPTION OF EXEMPLARY EMBODIMENTS

Reference will now be made in detail to the exemplary embodiments of the present invention, examples of which are illustrated in the accompanying drawings, wherein like reference numerals refer to like elements throughout.

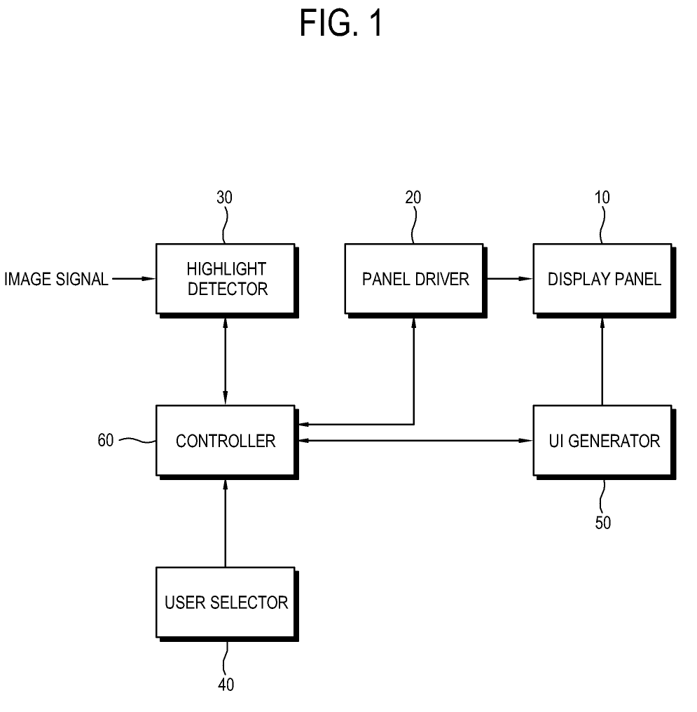

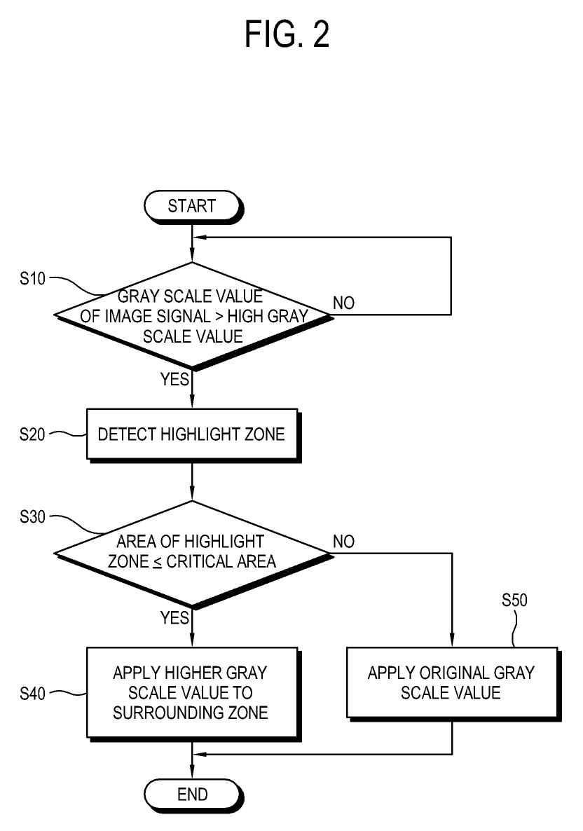

FIG. 1 is a control block diagram of a display apparatus according to an exemplary embodiment of the present invention. FIG. 2 is a control flow chart describing a control method of the display apparatus according to the exemplary embodiment.

As shown in FIG. 1, the display apparatus includes a display panel 10, a panel driver 20, a highlight detector 30, a user selector 40, a user interface (UI) generator 50 and a controller 60 which controls the display panel 10, the panel driver 20, the highlight detector 30, the user selector 40 and the UI generator 50.

The display panel 10 displays image signal and may include a liquid crystal display (LCD) panel having a liquid crystal layer, an organic light emitting diode (OLED) panel having an organic light emitting diode, and a plasma display panel (PDP). The display panel 10 may have a rectangular shape and include a plurality of pixels arranged as a matrix.

The panel driver 20 applies a gray scale value corresponding to an image signal to the pixels. The gray scale value may refer to an analog signal indicating a brightness of the image signal, or a decimal value of a digital signal indicating the brightness of the image signal or pixel data directly applied to the pixel corresponding to the decimal value. The gray scale value may correspond to any value to represent the brightness of the image signal and to control the brightness of the image signal. If the gray scale value is high, the brightness of the image signal is high. Conversely, the lower the gray scale value is, the lower the brightness of the image signal is. The panel driver 20 processes the image signal corresponding to a format of the display panel 10 and applies the processed image signal to the display panel 10. The image signal is input as the digital signal having a predetermined number of bits and hereinafter the gray scale value defines the decimal value of the bits. The gray scale value being applied to each pixel means that the pixel data corresponding to the gray scale value is provided to each pixel.

The highlight detector 30 detects a high gray level pixel or pixels and a highlight zone based on the gray scale value of the image signal. As shown in FIG. 2, the highlight detector 30 determines whether the gray scale value applied to every pixel is higher than the predetermined high gray scale value or a threshold at operation S10. For locally increasing the brightness of the pixel for display of, for example, the stars in the sky, a spark or a ripple shining in the sun, the high gray level pixel needs to be detected. If it is determined that the gray scale value of the image signal is not higher than the high gray scale value, the highlight detector 30 checks the image signal sequentially input. The high gray scale value may correspond to upper 5% to 25% of the maximum gray scale value. For example, when a gray scale level is divided into 256 levels of gray, the high gray scale value may be set to between 230 and 243, which is the upper 10% to 5% of 256.

The highlight detector 30 detects the highlight zone at operation S20. The highlight zone corresponds to a pixel group having the high gray level pixels. A gray scale difference between the boundary pixels of the pixel group, which corresponds to the highlight zone, and adjacent pixels is greater than a predetermined reference difference.

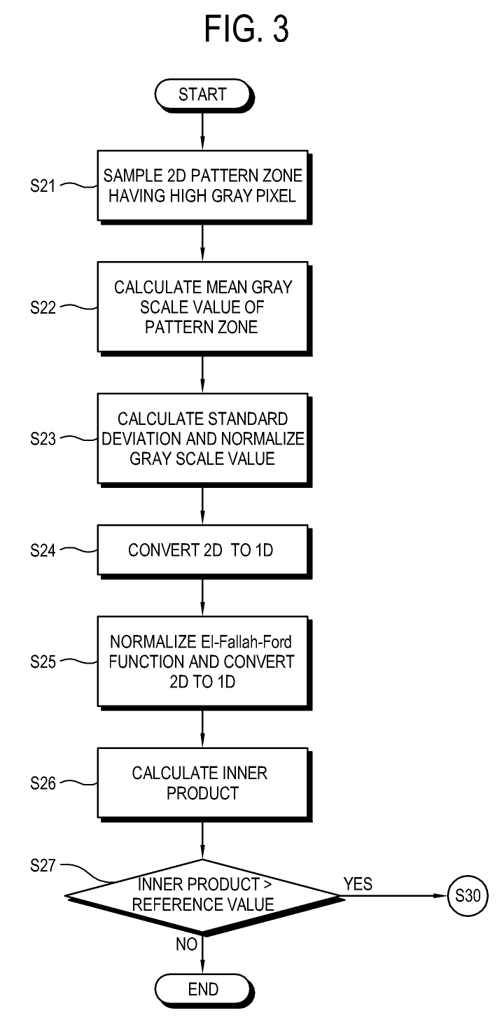

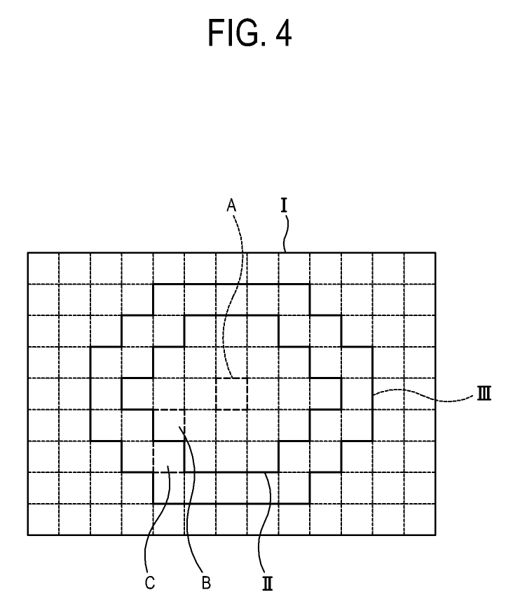

FIG. 3 is a control flow chart for determining the highlight zone in FIG. 2. FIG. 4 illustrates the highlight zone and a surrounding zone according to an exemplary embodiment. The highlight detector 30 samples a two-dimensional pattern zone, indicated as I in FIG. 4 including the high gray level pixel or pixels A at operation S21. The pattern zone I may have a polygon shape such as a square or a curved shape such as a circle or an ellipse. The highlight detector 30 calculates a mean gray scale value of the pattern zone I at operation S22. Next, the highlight detector 30 calculates a standard deviation using the mean gray scale value and normalizes the gray scale value of the pattern zone I based on the mean gray scale value at operation S23. The standard deviation is a square root of a mean value which refers to an average of a square of differences between each gray scale value and the mean gray scale value. The standard deviation is useful in determining a distribution of the gray scale values. The highlight detector 30 normalizes the gray scale values of the pattern zone I by dividing a difference between each gray scale value and the mean gray scale value by the standard deviation.

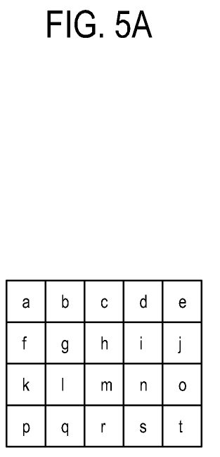

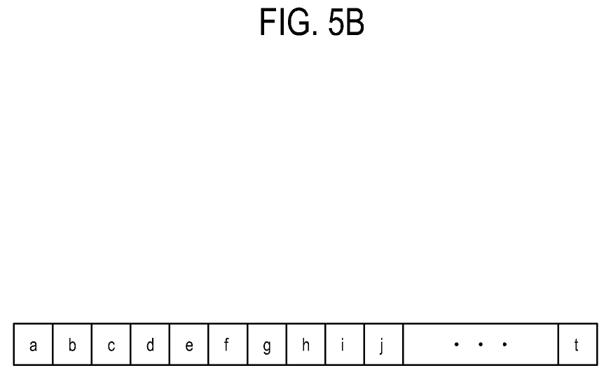

Next, for comparing a distribution of the gray scale value of the pattern zone I to a El-Fallah-Ford function, described in detail below, the highlight detector 30 converts the normalized two-dimensional gray scale values to a one-dimensional gray scale value at operation S24. FIG. 5A shows the normalized two-dimensional gray scale values of the pattern zone I, for pixels a through t. FIG. 5B shows the normalized one-dimensional gray scale values for pixels a through t. The normalization may imply the converting process. The normalization process is not limited to the method mentioned herein and may employ other known processes.

After the normalization of the pattern zone I, the highlight detector 30 normalizes the El-Fallah-Ford function and converts the normalized two-dimensional El-Fallah-Ford function to a one-dimensional El-Fallah-Ford function at operation S25. The El-Fallah-Ford function is a function applied to remove noise and is useful in a sharpening processor. The El-Fallah-Ford function may have an equation for the one-dimensional or two-dimensional operation. Formula 1 below is the El-Fallah-Ford function for the one-dimensional operation. Formula 2 is the El-Fallah-Ford function for the two-dimensional operation.

$$\begin{matrix}w ( x ) = \frac{1}{\sqrt{1 + {\vert \frac{x}{{σ}^{2}} \vert}^{μ}}} & [ Formula 1 ] \\ w ( x , y ) = \frac{1}{\sqrt{1 + {\vert \frac{\sqrt{{x}^{2} + {y}^{2}}}{{σ}^{2}} \vert}^{μ}}} & [ Formula 2 ]\end{matrix}$$

where σ and μ in formulas 1 and 2 are coefficients.

Various curves or curved surfaces may be created according to coefficients σ and μ.

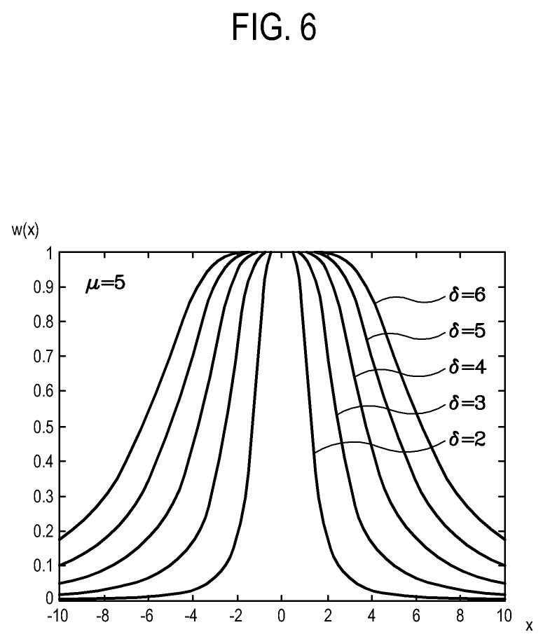

FIG. 6 shows one example of the one-dimensional El-Fallah-Ford function. As illustrated, the El-Fallah-Ford function is similar to a normal distribution graph having a central peak. In FIG. 6, the coefficient μ is a constant having a value of 5. The coefficient σ is changed to several variables from 2 to 6. Alternatively, the coefficient σ may be a constant and the coefficient μ may vary.

The highlight detector 30 calculates an inner product between the one-dimensional gray scale values and the one-dimensional El-Fallah-Ford in function S26. The inner product refers to a scalar product and is used for determining the similarity between the one-dimensional vectors of the El-Fallah-Ford function and the converted gray scale values. The inner product is in the range between −1 and 1. When the inner product is close to −1, the similarity between the one-dimensional vectors is great. When the inner product is close to 1, the similarity between the one-dimensional vectors is small.

The highlight detector 30 determines whether the inner product is greater than a predetermined reference value in S27. When the inner product is greater than the reference value, the highlight zone II is included in the pattern zone I. The highlight detector 30 extracts the pattern zone I including the high gray level pixels and detects the highlight zone II by comparing the pattern zone I to the El-Fallah-Ford function having the central peak.

In FIG. 4, the pattern zone I comprises the highlight zone II and boundary pixels B of the highlight zone II are the high gray level pixels. The boundary pixels B define a boundary of the highlight zone II. A difference between boundary pixels B and adjacent pixels is larger than a predetermined reference difference. The reference difference may adjust the range of the highlight zone II and be properly set by a user. For instance, the similarity between the gray scale value of the pattern zone II and the El-Fallah Ford function is higher at the reference value set to 0.8 than at the reference value set to 0.5. When the inner product is less than the reference value, the highlight detector 30 determines that there is no the highlight zone II in the pattern zone I.

Referring back to FIG. 2, when the highlight zone II is in the pattern zone I, the controller 60 determines whether an area of the highlight zone II is less than or equal to a predetermined critical area at operation S30. Because it is an aspect of the present embodiment to improve the brightness of pixels forming a small area within the area of the high level gray pixels, the area of the highlight zone II is restricted within the critical area. The critical area corresponds to the size of a star, or a sparkle and may be set or changed by a user.

If it is determined that the area of the highlight zone II is less than or equal to the critical area, the controller 60 controls the panel driver 20 to apply a gray scale value higher than that of the high gray level pixels A to a surrounding zone III disposed closely to the highlight zone II at operation S40. The surrounding zone III designates a pixel group surrounding a boundary line of the highlight zone II as shown in FIG. 4. If the area of the highlight zone II is very small, the brightness of the highlight zone II may appear to be visually decreased due to interference of the faint pixels surrounding the highlight zone. Thus, the controller 60 expands the area of the pixel group by applying the higher gray scale values to improve the quality of the image and visual verisimilitude of the image for a user. Therefore, the high gray scale value is applied to the surrounding zone III which originally may not have the high gray value pixels.

The surrounding zone III may be one pixel layer C enclosing the highlight zone II. Alternatively, a ratio of the surrounding zone III to the highlight zone II may vary. For instance, a total area of the surrounding zone III may be 5% to 20% of the area of the highlight zone II. The surrounding zone III may change depending on the size of the highlight zone II. In this case, the smaller the highlight zone II is, the larger the ratio of the surrounding zone III to the highlight zone II is. On the contrary, the larger the highlight zone II, the smaller the ratio of the surrounding zone III to the highlight zone II.

The gray scale value of the high gray level pixels or higher is applied to the surrounding zone III. The gray scale value applied to the surrounding zone III may be the sum of an original gray scale value and the gray scale value of the high gray level pixels or the maximum gray scale value. The maximum gray scale value is a gray scale value corresponding to the maximum brightness.

However, when the area of the highlight zone II is larger than the critical area, the panel driver 30 applies the original gray scale value to the pixels at operation S50.

The user selector 40 generates a control signal for controlling the display apparatus and outputs a various signal in response to manipulation of a user. The user selector 40 may include various input devices such as a remote controller, a touch panel, a hot key, a mouse or a keyboard. The user selector 40 functions as a user interface as well as facilitates input of the UI information generated by the UI generator 50. A user could set or change the high gray scale value, the reference difference, the reference value, the range of the pattern zone I, the critical area, the range of the surrounding zone III and/or the coefficients of the El-Fallah-Ford function via the user selector 40. The values of these parameters may be default or may be historically stored after user's manipulation.

The UI generator 50 generates UI information to set the above parameters by a user and displays the UI information on the display panel 10.

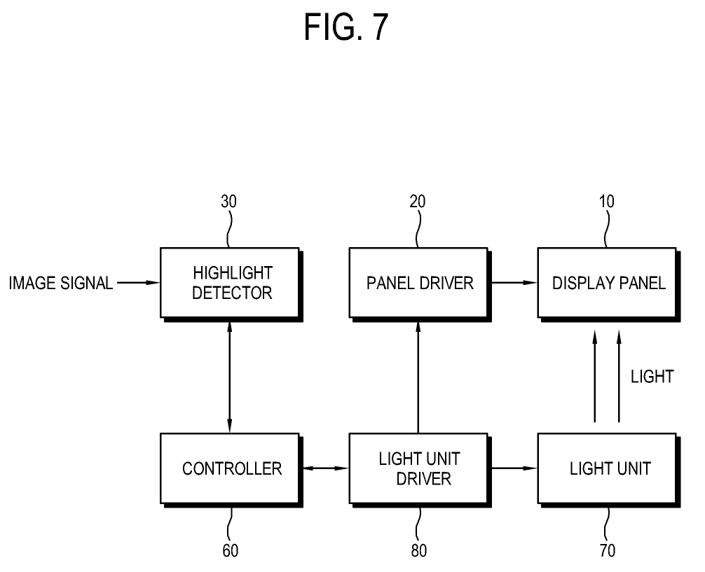

FIG. 7 is a control block diagram of a display apparatus according to an exemplary embodiment of the present invention. As shown, the display apparatus includes a light unit 70, which provides light to the display panel 10, and a light unit driver 80, which drives the light unit 70. The display apparatus according to this embodiment is a liquid crystal display including a backlight. Thus, the display panel 10 is a liquid crystal display panel having a liquid crystal layer.

The light unit 70 may include at least of a point light source, a line light source or a surface light source, and is arranged at the back of the display panel 10.

The light unit driver 80 supplies a driving power divided to different levels to the light unit 70 as controlled by the controller 60. The display apparatus adopts a local dimming controlling to adjust partly the brightness of light emitted from the light unit 70.

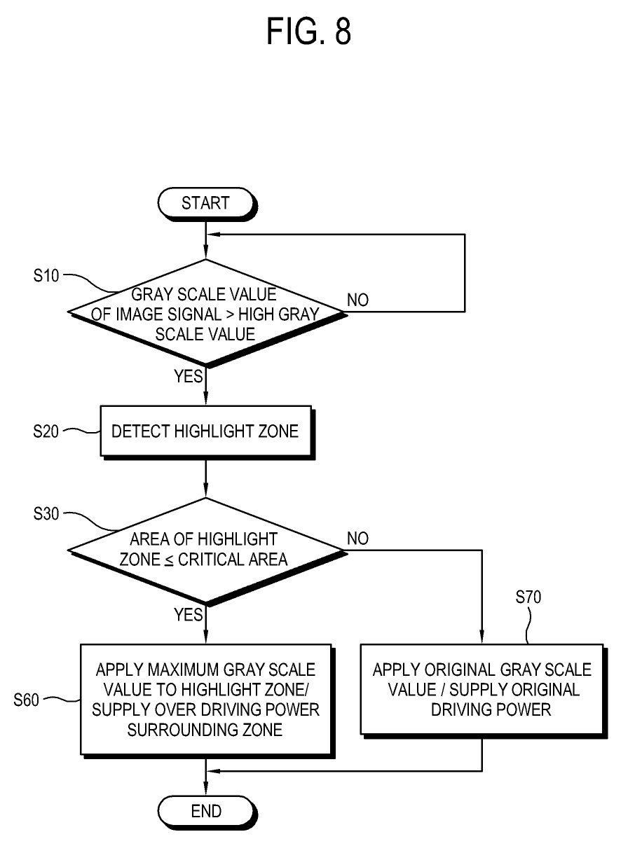

FIG. 8 is a control flow chart describing a control method of this embodiment. The operations S10 to S30 are similar to the control processes illustrated in FIG. 2 and FIG. 3. The controller 60 controls the panel driver 20 to apply the maximum gray scale value to the highlight zone II in operation S60 if the area of the highlight zone II is less than or equal to the critical area. Moreover, the controller 60 controls the light unit driver 80 to supply over driving power to the light unit so that the surrounding zone II has a brightness higher than that of the other zone at operation S60. The over driving power is greater than the driving power supplied to the other zone. The over driving power may be the maximum driving power that may be supplied to the light unit 70. The over driving power may be also supplied to the highlight zone II and not only the surrounding zone III.

While increasing the gray scale value of the surrounding zone III in the exemplary embodiment of FIG. 2, the maximum gray scale value is applied to the highlight zone (II) in this embodiment. Additionally, the high gray scale value or the maximum gray scale value may be applied to the surrounding zone III.

To improve the quality of the image having local highlight zone II, the area of the high gray level pixels or the gray scale values of the highlight zone II increase. Further, the driving power supplied to the display panel 20 may be increased.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A control method for a display apparatus having a display panel comprising a plurality of pixels, the method comprising:
detecting high gray level pixels having gray scale values greater than a predetermined high gray scale value;
detecting a highlight zone comprising the detected high gray pixels, wherein a gray scale value difference between boundary pixels of the highlight zone and adjacent pixels is greater than a predetermined reference difference; and
applying a gray scale value greater than a gray scale value of the high gray level pixels to a surrounding zone adjacent to the highlight zone.

2. The method of claim 1, further comprising:
determining whether an area of the highlight zone is equal to or less than a predetermined critical area; and
applying a gray scale value to the surrounding zone greater than the gray scale values of the high gray level pixels if the highlight zone comprises the critical area.

3. The method of claim 1, wherein the detecting the highlight zone comprises:
sampling a two-dimensional pattern zone having the high gray level pixels;
calculating a mean gray scale value of the pattern zone;
normalizing a gray scale value of the pattern zone using the mean gray scale value;
converting the normalized two-dimensional gray scale values to one-dimensional gray scale values;
normalizing a two-dimensional El-Fallah-Ford function;
converting the normalized two-dimensional El-Fallah-Ford function to a one-dimensional El-Fallah-Ford function;
calculating an inner product based on the one-dimensional El-Fallah-Ford function and the converted one-dimensional gray scale values;
comparing the inner product to a predetermined reference value; and
determining the highlight zone if the inner product is greater than the predetermined reference value.

4. The method of claim 3, wherein the El-Fallah-Ford function is calculated by setting coefficients.

5. The method of claim 1, wherein the surrounding zone comprises one pixel layer surrounding the highlight zone.

6. The method of claim 1, wherein the surrounding zone comprises from approximately 5% to approximately 20% of the highlight zone.

7. The method of claim 1, wherein the greater gray scale value is based on a sum of an original gray scale value of the surrounding zone and the gray scale value of the high gray level pixels.

8. The method of claim 1, further comprising:
applying a maximum gray scale value to the highlight zone.

9. A display apparatus comprising:
a display panel which has a plurality of pixels;
a panel driver which applies a gray scale value corresponding to an image signal to corresponding pixels;
a highlight detector which detects high gray level pixels having gray scale values greater than a predetermined high gray scale value, and a highlight zone comprising the detected high gray level pixels, wherein a gray scale value difference between boundary pixels of the highlight zone and adjacent pixels is greater than a predetermined reference difference; and
a controller which controls the panel driver to apply a gray scale value greater than a gray scale value of the high gray level pixels to a surrounding zone adjacent the highlight zone.

10. The display apparatus of claim 9, wherein the controller determines whether an area of the highlight zone is equal to or less than a predetermined critical area and controls the panel driver to apply a gray scale value greater than the gray scale values of the high gray level pixels to the surrounding zone if the highlight zone comprises the critical area.

11. The display apparatus of claim 9, wherein the highlight detector samples a two-dimensional pattern zone having the high gray level pixels, normalizes the gray scale values of the pattern zone, converts the normalized two-dimensional gray scale values to one-dimensional gray scale values, and calculates an inner product with a one-dimensional El-Fallah-Ford function and the converted one-dimensional gray scale values.

12. The display apparatus of claim 9, wherein the controller controls the panel driver to apply a maximum gray scale value to the highlight zone.

13. The display apparatus of claim 9, further comprising:
a light unit which provides light to the display panel and locally dims; and
a light unit driver which supplies driving power to the light unit to generate in the surrounding zone a higher brightness than a brightness of the highlight zone.
